(19) United States
(12) Patent Application Publication
(10) Pub. No.: US 2022/0314992 A1
(43) Pub. Date: Oct. 6, 2022

(54) VEHICLE CONTROL DEVICE, VEHICLE AND VEHICLE CONTROL METHOD

(71) Applicant: PANASONIC INTELLECTUAL PROPERTY MANAGEMENT CO., LTD., Osaka (JP)

(72) Inventor: Noriyuki TANI, Kanagawa (JP)

(73) Assignee: PANASONIC INTELLECTUAL PROPERTY MANAGEMENT CO., LTD., Osaka (JP)

(21) Appl. No.: 17/847,677

(22) Filed: Jun. 23, 2022

Related U.S. Application Data
(63) Continuation of application No. PCT/JP2020/037336, filed on Sep. 30, 2020.

(30) Foreign Application Priority Data
Dec. 24, 2019 (JP) 2019-233269

(51) Int. Cl. B60W 30/188; B60W 50/00; B60W 40/105

(52) U.S. Cl. CPC B60W 30/188; B60W 50/00; B60W 40/105; B60W 2520/28; B60W 2050/0012

(57) ABSTRACT

A vehicle control device includes a processor. The processor is configured to: output a torque command value related to a rotation speed of a wheel of a vehicle; specify an estimated value which is a value obtained by estimating the rotation speed of the wheel based on the torque command value; and determine a parameter based on an error between the estimated value and a measured value which is a value obtained by measuring the rotation speed of the wheel. The torque command value is determined by a feedforward control using a target value which is a value as a target of the rotation speed of the wheel and the parameter.

### CROSS-REFERENCE TO RELATED APPLICATIONS

This is a continuation of International Application No. PCT/JP2020/037336 filed on Sep. 30, 2020, and claims priority from Japanese Patent Application No. 2019-233269 filed on Dec. 24, 2019, the entire content of which is incorporated herein by reference.

### TECHNICAL FIELD

The present disclosure relates to a vehicle control device and a vehicle.

### BACKGROUND ART

In the related art, there is a known method in which feedforward control is used when a rotation speed of a wheel or a drive motor is controlled in an extremely low speed range. JP-A-2017-202805 discloses that when an output shaft rotation speed, in which an accuracy of an output shaft rotation speed sensor may not be maintained, is less than a predetermined rotation speed, an accuracy of a calculated value of a progress of a shaft is not guaranteed, and thus first motor torque and second motor torque are feedforward controlled in an inertia phase.

### SUMMARY OF INVENTION

The present disclosure provides a vehicle control device including a processor. The processor is configured to: output a torque command value related to a rotation speed of a wheel of a vehicle; specify an estimated value which is a value obtained by estimating the rotation speed of the wheel based on the torque command value; and determine a parameter based on an error between the estimated value and a measured value which is a value obtained by measuring the rotation speed of the wheel. The torque command value is determined by a feedforward control using a target value which is a value as a target of the rotation speed of the wheel and the parameter.

The present disclosure provides a vehicle including a wheel and a processor. The processor is configured to: output a torque command value related to a rotation speed of the wheel; specify an estimated value which is a value obtained by estimating the rotation speed of the wheel based on the torque command value; and determine a parameter based on an error between the estimated value and a measured value which is a value obtained by measuring the rotation speed of the wheel. The torque command value is determined by using a feedforward control a target value which is a value as a target of the rotation speed of the wheel and the parameter. Further, the present disclosure provides a vehicle control method including: outputting a torque command value related to a rotation speed of a wheel of a vehicle; specifying an estimated value which is a value obtained by estimating the rotation speed of the wheel based on the torque command value; and determining a parameter based on an error between the estimated value and a measured value which is a value obtained by measuring the rotation speed of the wheel. The torque command value is determined by a feedforward control using a target value which is a value as a target of the rotation speed of the wheel and the parameter.

These comprehensive or specific aspects may be implemented by a system, a device, a method, an integrated circuit, a computer program, or a recording medium, or may be implemented by any combination of the system, the device, the method, the integrated circuit, the computer program, and the recording medium.

### BRIEF DESCRIPTION OF DRAWINGS

FIG. 1 is a diagram illustrating a configuration example of a vehicle according to a first embodiment.

FIG. 2 is a diagram illustrating a configuration example of a braking control unit according to the first embodiment.

FIG. 3 is a flowchart illustrating a processing example of a parameter determination unit according to the first embodiment.

FIG. 4 is a diagram illustrating a configuration example of an estimation model corresponding to a controlled object in a wheel speed observer.

FIG. 5 is a diagram illustrating a configuration example of a braking control unit according to a second embodiment.

FIG. 6 is a flowchart illustrating a processing example of a parameter determination unit according to the second embodiment.

### DESCRIPTION OF EMBODIMENTS

Hereinafter, embodiments of the present disclosure will be described in detail with reference to the drawings as appropriate. However, an unnecessarily detailed description may be omitted. For example, a detailed description of well-known matters and a redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit a subject matter recited in claims.

### Introduction to Present Disclosure

In feedforward control in the related art, a change in a traveling resistance due to a change in a traveling environment of a vehicle is not taken into consideration. For example, even though traveling resistances of the vehicle are different in a case of traveling uphill or downhill and a case of traveling on a flat ground, in the feedforward control in the related art, control optimized for the flat ground is performed in both cases. Therefore, for example, when the vehicle traveling uphill or downhill is stopped at a desired position by automatic driving control, the feedforward control optimized for the flat ground is performed, and the vehicle stops at a position deviated from the desired position.

The present disclosure provides feedforward control in consideration of a change in a traveling resistance, and prevents a variation in a stop position of a vehicle due to a difference in the traveling resistance.

### First Embodiment

<Configuration of Vehicle>

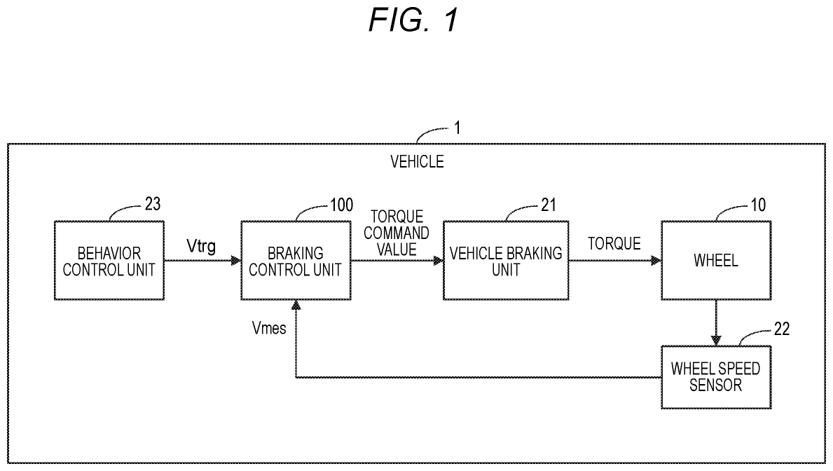

FIG. 1 illustrates a configuration example of a vehicle according to a first embodiment.

A vehicle 1 includes a wheel 10, a vehicle braking unit 21, a wheel speed sensor 22, a behavior control unit 23, and a braking control unit 100. If the vehicle 1 is a four-wheeled vehicle, the number of the wheels 10 may be four, and the number of the wheel speed sensors 22 may be four. In the following, one wheel 10 and the wheel speed sensor 22 that measures a speed of the wheel 10 will be described, but the description is also applicable to other wheels 10 and other wheel speed sensors 22.

The vehicle braking unit 21 is a mechanism for braking (driving) the wheel 10, and includes, for example, a drive motor, a transmission, a brake mechanism, and the like. The drive motor may be an electric motor, an internal combustion engine, or a combination thereof. The vehicle braking unit 21 accelerates or decelerates and stops the vehicle 1 by applying torque for acceleration or deceleration to a drive shaft (not illustrated) of the wheel 10.

The wheel speed sensor 22 is a device for measuring a rotation speed of the wheel 10. The wheel speed sensor 22 measures the rotational speed of the wheel 10, and transmits a wheel speed measured value Vmes, which is the measuring result. For example, the wheel speed sensor 22 detects a pulse cycle of a rotor rotating along with the wheel 10 or the drive shaft, and measures the wheel speed measured value Vmes based on the detected pulse cycle. Therefore, an accuracy of the wheel speed measured value Vmes is insufficient in an extremely low speed range where the pulse cycle is equal to or larger than a predetermined threshold. Therefore, in the extremely low speed range where the pulse cycle is equal to or larger than the predetermined threshold, feedforward control is performed instead of feedback control, as will be described later. The wheel speed measured value Vmes may be any of a rotation speed (for example, rpm), an angular velocity (for example, rad/ms), and a traveling speed (for example, km/h) based on a peripheral length of the wheel 10.

The behavior control unit 23 controls a behavior (for example, traveling, turning, or stopping) of the vehicle 1. In a case of the vehicle 1 operated by automatic driving control, the behavior control unit 23 automatically determines a speed, a steering angle, and the like of the vehicle 1 based on information obtained from various sensors such as a camera, a millimeter wave radar, and a positioning sensor provided in the vehicle 1. For example, the behavior control unit 23 determines a wheel speed target value Vtrg which is a value as a target of the rotation speed of the wheel 10, and transmits the determined wheel speed target value Vtrg to the braking control unit 100.

The braking control unit 100 is an example of a vehicle control device, and controls braking of the vehicle braking unit 21. The braking control unit 100 determines a torque command value related to the rotation speed of the wheel 10 based on the wheel speed target value Vtrg received from the behavior control unit 23 and the wheel speed measured value Vmes received from the wheel speed sensor 22, and transmits the determined torque command value to the vehicle braking unit 21. For example, when the vehicle braking unit 21 receives a positive torque command value from the braking control unit 100, the vehicle braking unit 21 determines a torque value based on the positive torque command value, and applies torque for acceleration corresponding to the determined torque value to the drive shaft of the wheel 10. For example, when the vehicle braking unit 21 receives a negative torque command value from the braking control unit 100, the vehicle braking unit 21 determines a torque value based on the negative torque command value, and applies torque for deceleration corresponding to the determined torque value to the drive shaft of the wheel 10. Details of the braking control unit 100 will be described later.

The behavior control unit 23 and the braking control unit 100 are implemented by individual electronic control units (ECUs). Alternatively, the behavior control unit 23 and the braking control unit 100 may be implemented by one ECU. The ECU may be implemented by a microcomputer, an integrated circuit, an application specific integrated circuit (ASIC), a programmable logic device (PLD) or a field-programmable gate array (FPGA) that implements a function of the present disclosure. Alternatively, the ECU may include a processor and a memory, and the processor may read and execute a computer program stored in the memory to implement the function of the present disclosure. Each ECU is connected to a communication network in the vehicle 1 and can transmit or receive information (or signals) via the communication network. Examples of the communication network in the vehicle 1 include a controller area network (CAN), a local interconnect network (LIN), a FlexRay, or a combination thereof

<Details of Braking Control Unit>

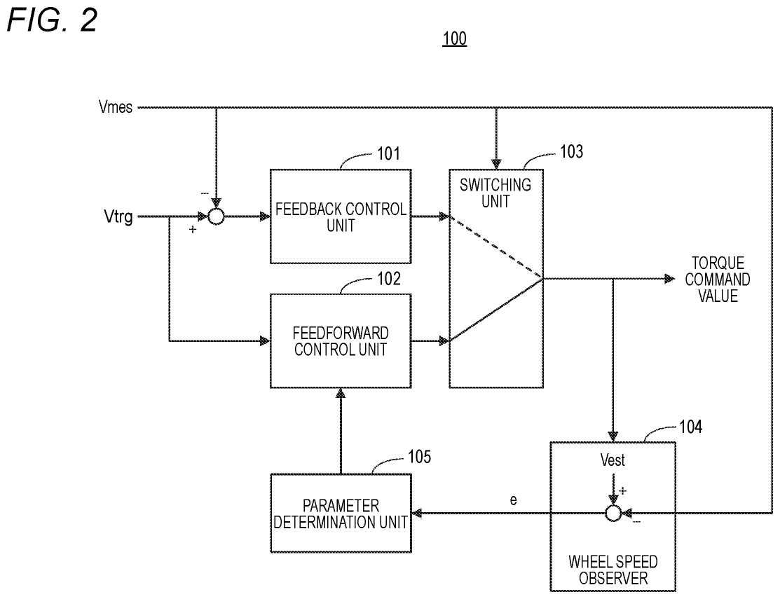

FIG. 2 is a diagram illustrating a configuration example of the braking control unit 100 according to the first embodiment.

The braking control unit 100 includes a feedback control unit 101, a feedforward control unit 102, a switching unit 103, a wheel speed observer 104, and a parameter determination unit 105. The term “observer” in the present disclosure means a state observer that observes an internal state of a control system based on a modern control theory.

The feedback control unit 101 determines a torque command value based on a value obtained by subtracting the wheel speed measured value Vmes received from the wheel speed sensor 22 from the wheel speed target value Vtrg received from the behavior control unit 23. The feedback control unit 101 outputs the determined torque command value to the switching unit 103.

The feedforward control unit 102 determines (calculates) a torque command value based on the wheel speed target value Vtrg received from the behavior control unit 23 and a parameter output from the parameter determination unit 105 described later. The feedforward control unit 102 outputs the determined torque command value to the switching unit 103.

The switching unit 103 switches an input source of the torque command value based on the wheel speed measured value Vmes received from the wheel speed sensor 22. For example, when the wheel speed measured value Vmes is equal to or larger than a predetermined threshold (third threshold), the switching unit 103 switches the input source of the torque command value to the feedback control unit 101. In this case, the torque command value output from the feedback control unit 101 is output to the vehicle braking unit 21. For example, when the wheel speed measured value Vmes is smaller than the predetermined threshold (third threshold) (that is, in the extremely low speed range), the switching unit 103 switches the input source of the torque command value to the feedforward control unit 102. In this case, the torque command value output from the feedforward control unit 102 is output to the vehicle braking unit 21. Accordingly, a reason for using the torque command value output from the feedforward control unit 102 instead of the feedback control unit 101 in the extremely low speed range is that, as described above, the accuracy of the feedback wheel speed measured value Vmes is insufficient in the extremely low speed range.

The wheel speed observer 104 is an example of a speed estimation unit, and calculates a wheel speed estimated value Vest, which is a value obtained by estimating the rotation speed of the wheel 10, based on the torque command value output from the switching unit 103. The wheel speed observer 104 calculates a wheel speed estimation error e by subtracting the wheel speed estimated value Vest from the wheel speed measured value Vmes received from the wheel speed sensor 22. Therefore, if the wheel speed measured value Vmes is larger than the wheel speed estimated value Vest, the wheel speed estimation error e is a positive value, and if the wheel speed measured value Vmes is smaller than the wheel speed estimated value Vest, the wheel speed estimation error e is a negative value. The wheel speed observer 104 outputs the calculated wheel speed estimation error e to the parameter determination unit 105.

The parameter determination unit 105 determines a parameter used by the feedforward control unit 102 to determine the torque command value based on the wheel speed estimation error e output from the wheel speed observer 104, and outputs the determined parameter to the feedforward control unit 102.

If the wheel speed estimation error e is a negative value, the wheel speed measured value Vmes is smaller than the wheel speed estimated value Vest. In this case, since the vehicle 1 is traveling uphill, the wheel 10 may rotate slower than the wheel speed estimated value Vest. Therefore, in this case, the parameter determination unit 105 determines, as an uphill parameter, a parameter used by the feedforward control unit 102 to determine the torque command value. That is, if the wheel speed estimation error e is smaller than a predetermined threshold (first threshold) −Vth (<0) (e<−Vth), the parameter determination unit 105 determines, as the uphill parameter (first parameter), the parameter used by the feedforward control unit 102 to determine the torque command value.

If the wheel speed estimation error e is a positive value, the wheel speed measured value Vmes is larger than the wheel speed estimated value Vest. In this case, since the vehicle 1 is traveling downhill, the wheel 10 may rotate faster than the wheel speed estimated value Vest. Therefore, in this case, the parameter determination unit 105 determines, as a downhill parameter, the parameter used by the feedforward control unit 102 to determine the torque command value. That is, if the wheel speed estimation error e is smaller than a predetermined threshold (second threshold) Vth (>0) (e>Vth), the parameter determination unit 105 determines, as the downhill parameter (second parameter), the parameter used by the feedforward control unit 102 to determine the torque command value.

If the wheel speed estimation error e is within a predetermined range including 0, the wheel speed estimated value Vest substantially matches the wheel speed measured value Vmes. In this case, since the vehicle 1 is traveling on a flat ground, the wheel speed estimated value Vest substantially matches the wheel speed measured value Vmes. Therefore, in this case, the parameter determination unit 105 determines, as a flat ground (usual) parameter, the parameter used by the feedforward control unit 102 to determine the torque command value. That is, if the wheel speed estimation error e is equal to or larger than the first threshold −Vth and equal to or smaller than the predetermined second threshold Vth (−Vth<e<Vth), the parameter determination unit 105 determines, as the flat ground parameter (third parameter), the parameter used by the feedforward control unit 102 to determine the torque command value.

The uphill parameter is a parameter by which the torque command value is calculated to be larger than the torque command value calculated by the flat ground parameter. The downhill parameter is a parameter by which the torque command value is calculated to be smaller than the torque command value calculated by the flat ground parameter. Accordingly, as compared with a case where the torque command value is calculated using only the flat ground parameter, the feedforward control unit 102 can calculate the torque command value suitable for an environmental condition while the vehicle 1 is traveling. That is, the drive shaft of the wheel 10 can be rotated with torque suitable for the environmental condition while the vehicle 1 is traveling.

For example, in the related art, also in automatic stop control on a downhill, the torque command value is calculated using only the flat ground parameter, and thus the vehicle 1 stops behind a target stop position. Meanwhile, in the present embodiment, the torque command value is calculated using the downhill parameter in the automatic stop control on a downhill, and thus the vehicle 1 stops at the target stop position.

Similarly, in the related art, also in automatic stop control on an uphill, the torque command value is calculated using only the flat ground parameter, and thus the vehicle 1 stops before the target stop position. Meanwhile, in the present embodiment, the torque command value is calculated using the uphill parameter in the automatic stop control on an uphill, and thus the vehicle 1 stops at the target stop position.

<Processing Example of Parameter Determination Unit>

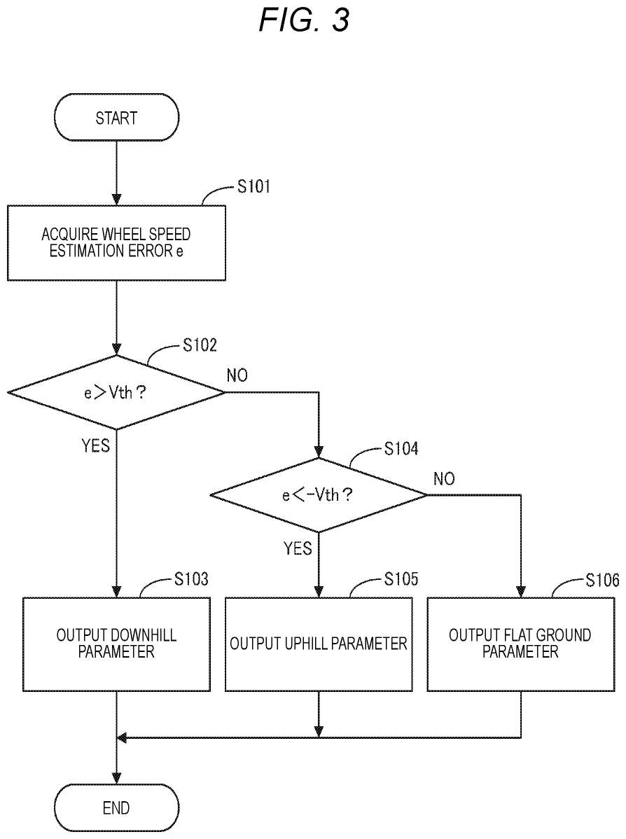

FIG. 3 is a flowchart illustrating a processing example of the parameter determination unit 105 according to the first embodiment.

The parameter determination unit 105 acquires the wheel speed estimation error e from the wheel speed observer 104 (S101).

The parameter determination unit 105 determines whether the wheel speed estimation error e is larger than the threshold Vth (S102).

If the wheel speed estimation error e is larger than the threshold Vth (S102: YES), the parameter determination unit 105 outputs the downhill parameter to the feedforward control unit 102 (S103), and ends the processing.

If the wheel speed estimation error e is equal to or smaller than the threshold Vth (S102: NO), the parameter determination unit 105 executes next processing of S104.

The parameter determination unit 105 determines whether the wheel speed estimation error e is smaller than the threshold −Vth (S104).

If the wheel speed estimation error e is smaller than the threshold −Vth (S104: YES), the parameter determination unit 105 outputs the uphill parameter to the feedforward control unit 102 (S105), and ends the processing.

If the wheel speed estimation error e is equal to or larger than the threshold −Vth (S104: NO), the parameter determination unit 105 outputs the flat ground parameter to the feedforward control unit 102 (S106), and ends the processing.

In the above, an example of using two thresholds Vth and −Vth to determine three parameters of the uphill parameter, the downhill parameter, and the flat ground parameter has been described, but the uphill parameter and/or downhill parameter may be switched in a plurality of stages. For example, if the wheel speed estimation error e>a threshold Vth2, the parameter determination unit 105 determines the parameter as the downhill parameter, and if the threshold Vth2≥the wheel speed estimation error e>a threshold Vth1, the parameter determination unit 105 may determine the parameter as a gentle downhill parameter. If the wheel speed estimation error e<a threshold −Vth2, the parameter determination unit 105 determines the parameter as the uphill parameter, and if the threshold −Vth2<the wheel speed estimation error e<a threshold −Vth1, the parameter determination unit 105 may determine the parameter as a gentle uphill parameter. If the threshold −Vth1≤the wheel speed estimation error e<the threshold Vth1, the parameter determination unit 105 may determine the parameter as the flat ground parameter.

<Modification>

In the above, an example in which the wheel speed observer 104 outputs the wheel speed estimation error e has been described, but the wheel speed observer 104 may output a value different from the wheel speed estimation error e.

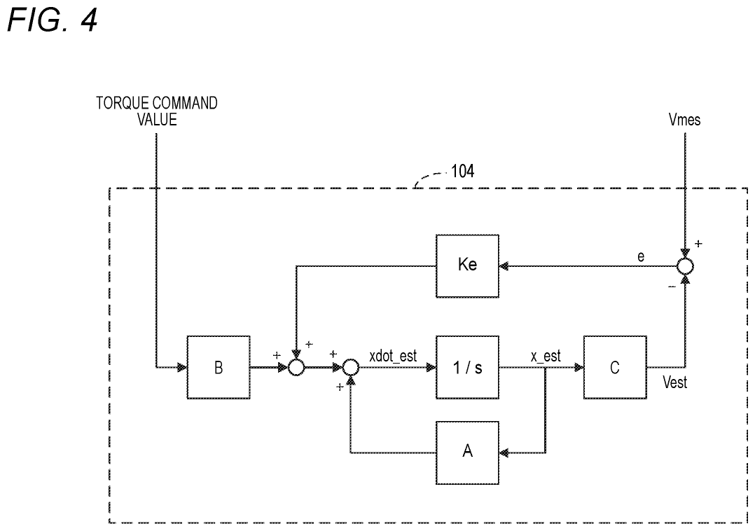

FIG. 4 is a diagram illustrating a configuration example of an estimation model corresponding to a controlled object in the wheel speed observer 104. Next, with reference to FIG. 4, an example in which the wheel speed observer 104 outputs the value different from the wheel speed estimation error e will be described. The controlled object in the present description is the vehicle braking unit 21. Alternatively, the controlled object may be the vehicle braking unit 21 and the wheel 10.

In the estimation model illustrated in FIGS. 4, A, B, and C indicate matrices determined based on the controlled object. 1/s indicates a time integral in a Laplace transform. Ke indicates a predetermined observer gain.

As illustrated in FIG. 4, in the estimation model, in addition to the wheel speed estimation error e, a state quantity estimated value x_est and a state quantity estimated value differential quantity xdot_est are calculated. The state quantity estimated value x_est is a value obtained by time-integrating the state quantity estimated value differential quantity xdot_est. The state quantity estimated value differential quantity xdot_est is a sum of a value obtained by multiplying the torque command value input to the wheel speed observer 104 by the matrix B, a value obtained by multiplying the wheel speed estimation error e by the observer gain Ke, and a value obtained by multiplying the state quantity estimated value x_est by the matrix B.

The wheel speed observer 104 may output, to the parameter determination unit 105, the state quantity estimated value x_est or the state quantity estimated value differential quantity xdot_est instead of the wheel speed estimation error e.

The parameter determination unit 105 may determine the uphill parameter (first parameter), the downhill parameter (second parameter), and the flat ground parameter (third parameter) by using a predetermined threshold for determining the state quantity estimated value x_est or the state quantity estimated value differential quantity xdot_est, instead of the above thresholds Vth and −Vth for determining the wheel speed estimation error e.

### Second Embodiment

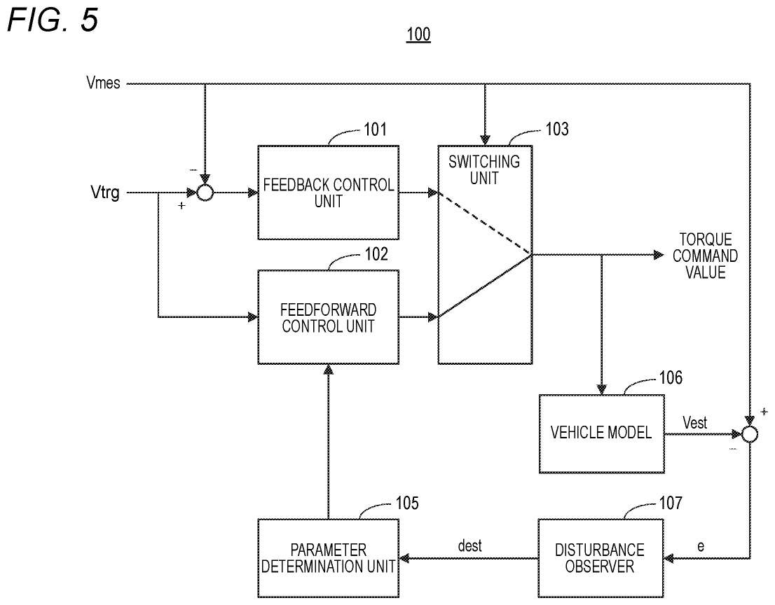

FIG. 5 is a diagram illustrating a configuration example of the braking control unit 100 according to a second embodiment. In the second embodiment, the components described in the first embodiment may be designated by common reference numerals and the descriptions thereof may be omitted.

The braking control unit 100 includes the feedback control unit 101, the feedforward control unit 102, the switching unit 103, a vehicle model 106, a disturbance observer 107, and the parameter determination unit 105.

The vehicle model 106 is an example of the speed estimation unit, and outputs the wheel speed estimated value Vest based on the torque command value output from the switching unit 103 (feedforward control unit 102). The vehicle model 106 is a model of the vehicle braking unit 21 and the wheel 10.

The disturbance observer 107 is an example of a disturbance estimation unit, and outputs a disturbance estimated value dest which is a value obtained by estimating a disturbance based on the wheel speed estimation error e obtained by subtracting the wheel speed estimated value Vest output from the vehicle model 106 from the wheel speed measured value Vmes output from the wheel speed sensor 22. The disturbance observer 107 may be configured as a reverse model of the vehicle model 106.

The parameter determination unit 105 determines the parameter used by the feedforward control unit 102 to determine the torque command value based on the disturbance estimated value dest output from the disturbance observer 107, and outputs the determined parameter to the feedforward control unit 102.

When the disturbance estimated value dest is a negative value, the wheel speed measured value Vmes is smaller than the wheel speed estimated value Vest. In this case, since the vehicle 1 is traveling uphill, the wheel 10 may rotate slower than the wheel speed estimated value Vest. Therefore, in this case, the parameter determination unit 105 determines, as the uphill parameter, the parameter used by the feedforward control unit 102 to calculate the torque command value. That is, if the disturbance estimated value dest is smaller than a predetermined threshold (first threshold) −dth (<0) (dest<−dth), the parameter determination unit 105 determines, as the uphill parameter (first parameter), the parameter used by the feedforward control unit 102 to calculate the torque command value.

If the disturbance estimated value dest is a positive value, the wheel speed measured value Vmes is larger than the wheel speed estimated value Vest. In this case, since the vehicle 1 is traveling downhill, the wheel 10 may rotate faster than the wheel speed estimated value Vest. Therefore, in this case, the parameter determination unit 105 determines, as the downhill parameter, the parameter used by the feedforward control unit 102 to calculate the torque command value. That is, if the disturbance estimated value dest is larger than a predetermined threshold (second threshold) dth (>0) (dest>dth), the parameter determination unit 105 determines, as the downhill parameter (second parameter), the parameter used by the feedforward control unit 102 to calculate the torque command value.

If the disturbance estimated value dest is within a predetermined range including 0, the wheel speed estimated value Vest substantially matches the wheel speed measured value Vmes. In this case, since the vehicle 1 is traveling on a flat ground, the wheel speed estimated value Vest substantially matches the wheel speed measured value Vmes. Therefore, in this case, the parameter determination unit 105 determines, as the flat ground (usual) parameter, the parameter used by the feedforward control unit 102 to calculate the torque command value. That is, if the disturbance estimated value dest is equal to or larger than the predetermined threshold (first threshold) −dth and equal to or smaller than the predetermined threshold (second threshold) dth (−dth≤dest≤dth), the parameter determination unit 105 determines, as the flat ground parameter (third parameter), the parameter used by the feedforward control unit 102 to calculate the torque command value.

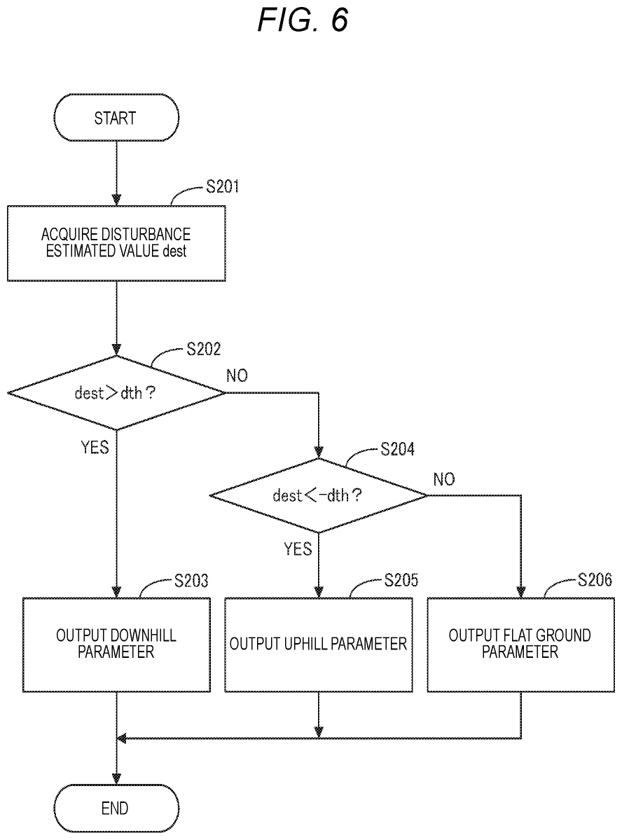

FIG. 6 is a flowchart illustrating a processing example of the parameter determination unit 105 according to the second embodiment.

The parameter determination unit 105 acquires the disturbance estimated value dest from the disturbance observer 107 (S201).

The parameter determination unit 105 determines whether the disturbance estimated value dest is larger than the threshold dth (S202).

If the disturbance estimated value dest is larger than the threshold dth (S202: YES), the parameter determination unit 105 outputs the downhill parameter to the feedforward control unit 102 (S203), and ends the processing.

If the disturbance estimated value dest is equal to or smaller than the threshold dth (S202: NO), the parameter determination unit 105 executes next processing of S204.

The parameter determination unit 105 determines whether the disturbance estimated value dest is smaller than the threshold −dth (S204).

If the disturbance estimated value dest is smaller than the threshold −dth (S204: YES), the parameter determination unit 105 outputs the uphill parameter to the feedforward control unit 102 (S205), and ends the processing.

If the disturbance estimated value dest is equal to or larger than the threshold −dth (S204: NO), the parameter determination unit 105 outputs the flat ground parameter to the feedforward control unit 102 (S206), and ends the processing.

In the above, an example of using two thresholds dth and −dth to determine three parameters of the uphill parameter, the downhill parameter, and the flat ground parameter has been described, but the uphill parameter and/or downhill parameter may be switched in a plurality of stages. For example, if the disturbance estimated value dest>a threshold dth2, the parameter determination unit 105 determines the parameter as the downhill parameter, and if the threshold Vth2≥the disturbance estimated value dest>a threshold dth1, the parameter determination unit 105 may determine the parameter as the gentle downhill parameter. If the disturbance estimated value dest<a threshold −dth2, the parameter determination unit 105 determines the parameter as the uphill parameter, and if the threshold −dth2≤the disturbance estimated value dest≤a threshold −dth1, the parameter determination unit 105 may determine the parameter as the gentle uphill parameter. If the threshold −dth1≤the disturbance estimated value dest≤the threshold dth1, the parameter determination unit 105 may determine the parameter as the flat ground parameter.

### Modification Common to First and Second Embodiments

The thresholds and the parameter in the parameter determination unit 105 described above are examples. For example, the threshold (first threshold) for determining whether to output the downhill parameter in S102 or S202 may be any value as long as the value is positive. For example, the threshold (second threshold) for determining whether to output the uphill parameter in S104 or S204 may be any value as long as the value is negative.

Further, in the above description, an example in which the parameter determination unit 105 has the third parameter for the flat ground and the first parameter and the second parameter for uphill and downhill, respectively has been described, the number of parameters possessed by the parameter determination unit 105 is not limited to three. For example, the parameter determination unit 105 may have two or more parameters for uphill and/or downhill, respectively.

Alternatively, the parameter determination unit 105 may determine the parameter to be output to the feedforward control unit 102 based on a predetermined function or map with the wheel speed estimation error e or the disturbance estimated value dest as a variable.

It has been described above that if the wheel speed measured value Vmes is larger than the wheel speed estimated value Vest, the vehicle 1 is traveling downhill, and if the wheel speed measured value Vmes is smaller than the wheel speed estimated value Vest, the vehicle 1 is traveling uphill. However, the downhill is an example of a case where the traveling resistance is small, and the uphill is an example of a case where the traveling resistance is large. Therefore, the uphill parameter may be read as the first parameter corresponding to the case where the traveling resistance is large, and the downhill parameter may be read as the second parameter corresponding to the case where the traveling resistance is small. Another example of a large traveling resistance may include a case where a road surface is unpaved (for example, a gravel road or a forest road). Another example of a small traveling resistance may include a case where a road surface is covered with water or ice.

### Summary of Present Disclosure

A vehicle control device (100) according to an aspect of the present disclosure includes: a feedforward control unit (102) configured to output a torque command value related to a rotation speed of a wheel (10) of a vehicle (1); a speed estimation unit (104, 106) configured to specify an estimated value which is a value, estimated based on the torque command value, of the rotation speed of the wheel; and a parameter determination unit (105) configured to determine a parameter used by the feedforward control unit to determine the torque command value based on an error between the estimated value and a measured value which is a value obtained by measuring the rotation speed of the wheel. The feedforward control unit determines the torque command value to be output by using a target value which is a value as a target of the rotation speed of the wheel and the parameter determined by the parameter determination unit.

According to the above configuration, the feedforward control unit determines the torque command value by using the parameter determined based on the error between the measured value and the estimated value, and thus as compared with a case where the torque command value is determined by using a single parameter, feedforward control can be provided in consideration of changes in a traveling resistance. Therefore, variations can be provided in a stop position of the vehicle due to a difference in the traveling resistance.

If the error is smaller than a first threshold which is a negative value, the parameter determination unit (105) determines the above parameter as a first parameter, if the error is larger than a second threshold which is a positive value, the parameter determination unit (105) determines the above parameter as a second parameter, and if the error is equal to or larger than the first threshold and equal to or smaller than the second threshold, the parameter determination unit (105) may determine the above parameter as a third parameter. Here, the torque command value when the first parameter is used may be larger than the torque command value when the third parameter is used, and the torque command value when the second parameter is used may be smaller than the torque command value when the third parameter is used.

According to the above configuration, for example, on an uphill where the traveling resistance is larger than that on a flat ground, the parameter is determined as the first parameter, and thus the feedforward control unit outputs the torque command value larger than that in a case of the flat ground. In addition, on a downhill where the traveling resistance is smaller than that on the flat ground, the parameter is determined as the second parameter, and thus the feedforward control unit outputs the torque command value smaller than that in the case of the flat ground. Therefore, variations can be provided in stop positions of the vehicle on the flat ground, the uphill, and the downhill.

The vehicle control device (100) may further include a disturbance estimation unit (107) configured to output a disturbance estimated value which is a value obtained by estimating a disturbance. If the disturbance estimated value is smaller than the first threshold which is the negative value, the parameter determination unit (105) determines the above parameter as the first parameter, if the disturbance estimated value is larger than the second threshold which is the positive value, the parameter determination unit (105) determines the above parameter as the second parameter, and if the disturbance estimated value is equal to or larger than the first threshold and equal to or smaller than the second threshold, the parameter determination unit (105) may determine the above parameter as the third parameter. Here, the torque command value when the first parameter is used may be larger than the torque command value when the third parameter is used, and the torque command value when the second parameter is used may be smaller than the torque command value when the third parameter is used.

According to the above configuration, for example, on the uphill where the traveling resistance is larger than that on the flat ground, the parameter is determined as the first parameter, and thus the feedforward control unit outputs the torque command value larger than that in the case of the flat ground. In addition, on the downhill where the traveling resistance is smaller than that on the flat ground, the parameter is determined as the second parameter, and thus the feedforward control unit outputs the torque command value smaller than that in the case of the flat ground. Therefore, the variations can be provided in the stop positions of the vehicle on the flat ground, the uphill, and the downhill.

The vehicle control device (100) may further include: a feedback control unit (101) configured to output the torque command value based on a difference between the target value and the measured value; and a switching unit (103) configured to output the torque command value output from the feedback control unit when the measured value is equal to or larger than a third threshold, and output the torque command value output from the feedforward control unit (102) when the measured value is smaller than the third threshold. The wheel (10) may be rotationally driven based on the torque command value output from the switching unit.

According to the above configuration, when the measured value is smaller than the third threshold (for example, in an extremely low speed range), the wheel is rotationally driven based on the torque command value output from the feedforward control unit. Therefore, the wheel can be prevented from being rotationally driven by feedback control based on the measured value having an insufficient accuracy in the extremely low speed range, and the variations in the stop positions of the vehicle can be prevented.

Although the embodiments have been described with reference to the accompanying drawings, the present disclosure is not limited to such examples. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, the constituent elements in the above-described embodiment may be combined as desired without departing from the gist of the invention.

The present application is based on a Japanese patent application filed on Dec. 24, 2019 (Japanese Patent Application No. 2019-233269), and the contents of which are incorporated herein by reference.

The technique of the present disclosure is useful for behavior control in an extremely low speed range of a vehicle operated by automatic driving control.

What is claimed is:

1. A vehicle control device comprising:
a processor,
wherein the processor is configured to:
output a torque command value related to a rotation speed of a wheel of a vehicle;
specify an estimated value which is a value obtained by estimating the rotation speed of the wheel based on the torque command value; and
determine a parameter based on an error between the estimated value and a measured value which is a value obtained by measuring the rotation speed of the wheel,
wherein the torque command value is determined by a feedforward control using a target value which is a value as a target of the rotation speed of the wheel and the parameter.

2. The vehicle control device according to claim 1,
wherein the processor is configured to:
determine the parameter as a first parameter in a case in which the error is smaller than a first threshold which is a negative value;
determine the parameter as a second parameter in a case in which the error is larger than a second threshold which is a positive value; and
determine the parameter as a third parameter in a case in which the error is equal to or larger than the first threshold and equal to or smaller than the second threshold,
wherein the torque command value in a case in which the first parameter is used is larger than the torque command value in a case in which the third parameter is used, and
wherein the torque command value in a case in which the second parameter is used is smaller than the torque command value in a case in which the third parameter is used.

3. The vehicle control device according to claim 2,
wherein an absolute value of the first threshold is equal to an absolute value of the second threshold.

4. The vehicle control device according to claim 2,
wherein a plurality of negative threshold ranges are defined by one or more thresholds smaller than the first threshold, and
wherein in a case in which the error is smaller than the first threshold, the parameter is selected from a plurality of parameters based on the error, the plurality of parameters being set for the respective negative threshold ranges.

5. The vehicle control device according to claim 2,
wherein a plurality of positive threshold ranges are defined by one or more thresholds larger than the second threshold, and
wherein in a case in which the error is larger than the second threshold, the parameter is selected from a plurality of parameters based on the error, the plurality of parameters being set for the respective positive threshold ranges.

6. The vehicle control device according to claim 1,
wherein the processor is configured to:
output a disturbance estimated value which is a value obtained by estimating a disturbance;
determine the parameter as a first parameter in a case in which the disturbance estimated value is smaller than a first threshold which is a negative value,
determine the parameter as a second parameter in a case in which the disturbance estimated value is larger than a second threshold which is a positive value, and
determine the parameter as a third parameter in a case in which the disturbance estimated value is equal to or larger than the first threshold and equal to or smaller than the second threshold,
wherein the torque command value in a case in which the first parameter is used is larger than the torque command value in a case in which the third parameter is used, and
wherein the torque command value in a case in which the second parameter is used is smaller than the torque command value in a case in which the third parameter is used.

7. The vehicle control device according to claim 6,
wherein an absolute value of the first threshold is equal to an absolute value of the second threshold.

8. The vehicle control device according to claim 6,
wherein a plurality of negative threshold ranges are defined by one or more thresholds smaller than the first threshold, and
wherein in a case in which the disturbance estimated value is smaller than the first threshold, the parameter is selected from a plurality of parameters based on the disturbance estimated value, the plurality of parameters being set for the respective negative threshold ranges.

9. The vehicle control device according to claim 6,
wherein a plurality of positive threshold ranges are defined by one or more thresholds larger than the second threshold, and
wherein in a case in which the disturbance estimated value is larger than the second threshold, the parameter is selected from a plurality of parameters based on the disturbance estimated value, the plurality of parameters being set for the respective positive threshold ranges.

10. The vehicle control device according to claim 6,
wherein the parameter is determined based on a function or a map with the disturbance estimated value as a variable.

11. The vehicle control device according to claim 1,
wherein the processor is configured to:
output the torque command value determined by a feedback control using a difference between the target value and the measured value in a case in which the measured value is equal to or larger than the third threshold, and output the torque command value determined by the feedforward control in a case in which the measured value is smaller than the third threshold, and
wherein the wheel is rotationally driven based on the torque command value.

12. The vehicle control device according to claim 1,
wherein the parameter is determined based on a state quantity estimated value or a state quantity estimated value differential quantity,
wherein the state quantity estimated value differential quantity is obtained based on the error, the torque command value and the state quantity estimated value, and
wherein the state quantity estimated value is obtained by integrating the state quantity estimated value differential quantity.

13. The vehicle control device according to claim 1,
wherein the parameter is determined based on a function or a map with the error as a variable.

14. A vehicle comprising:
a wheel; and
a processor,
wherein the processor is configured to:
output a torque command value related to a rotation speed of the wheel;
specify an estimated value which is a value obtained by estimating the rotation speed of the wheel based on the torque command value; and
determine a parameter based on an error between the estimated value and a measured value which is a value obtained by measuring the rotation speed of the wheel,
wherein the torque command value is determined by using a feedforward control a target value which is a value as a target of the rotation speed of the wheel and the parameter.

15. A vehicle control method comprising:
outputting a torque command value related to a rotation speed of a wheel of a vehicle;
specifying an estimated value which is a value obtained by estimating the rotation speed of the wheel based on the torque command value; and
determining a parameter based on an error between the estimated value and a measured value which is a value obtained by measuring the rotation speed of the wheel,
wherein the torque command value is determined by a feedforward control using a target value which is a value as a target of the rotation speed of the wheel and the parameter.
